(19) United States
(12) Patent Application Publication
(10) Pub. No.: US 2014/0151913 A1
(43) Pub. Date: Jun. 5, 2014

(54) COST EFFECTIVE Y2O3 SYNTHESIS AND RELATED FUNCTIONAL NANOCOMPOSITES

(71) Applicant: CORNING INCORPORATED, Corning, NY (US)

(72) Inventors: Johnny Glen Arroyo, Painted Post, NY (US); LinLin Chen, Corning, NY (US); Weiguo Miao, Horseheads, NY (US)

(73) Assignee: CORNING INCORPORATED, Corning, NY (US)

(21) Appl. No.: 14/070,856

(22) Filed: Nov. 4, 2013

Related U.S. Application Data
(60) Provisional application No. 61/731,900, filed on Nov. 30, 2012.

(51) Int. Cl. C01F 17/00

(52) U.S. Cl. CPC C01F 17/0043
USPC 264/8; 423/263

(57) ABSTRACT

In one aspect the disclosure is directed to a method for inexpensively producing a Y₂O₃ nano-powder material, thereby facilitating the increased utilization of the material in different commercial application. In another aspect the disclosure is directed to Y₂O₃ nano-powder composite materials consisting of Y₂O₃ and at least one oxide selected from the group consisting of MgO, CaO, BeO₂, Al₂O3, TiO₂, ZrO₂, SiO₂, HfO₂, YbO₂, GdO₂, Lu₂O₃ and additional rare earth oxides.

This application claims the benefit of priority under 35 U.S.C. §119 of U.S. Provisional Application Ser. No. 61/731,900 filed on Nov. 30, 2012 the content of which is relied upon and incorporated herein by reference in its entirety.

### FIELD

This disclosure is directed to a cost effective method of synthesizing yttrium oxide, Y₂O₃, nano-powders and to composited made using such powders.

### BACKGROUND

High performance, good erosion resistant multi-band transparent materials are in the strong demand for different application such as optical window coatings, medical instruments, lasers, lighting devices and other uses. Yttrium oxide, Y₂O₃, is one of the promising candidates with excellent optical performance through mid-range IR wavelengths at both ambient and elevated temperatures, and though it has low scattering and great machinability/shaping ability, it has limited commercial market due to its current high cost issue as well as thermo-mechanical properties that need improvement. Currently, the pure Y₂O₃ nano-sized powders are very expensive, and the breaking-down processing of the soft agglomeration of nano-powders for compacting is very time-consuming and costly. In addition, the inadequate mechanical properties of pure Y₂O₃ powders have limited its applications in coatings, illuminating devices and other areas. As a result, the production of lower-cost pure nano-sized Y₂O₃ powders is desired.

### SUMMARY

In one aspect the disclosure is directed to a method for inexpensively producing a Y₂O₃ nano-powder material, thereby facilitating the increased utilization of the material in different commercial application. In another aspect the disclosure is directed to Y₂O₃ nano-powder composite materials consisting of Y₂O₃ and at least one oxide selected from the group consisting of MgO, CaO, BeO₂, Al₂O3, TiO₂, ZrO₂, SiO₂, HfO₂, YbO₂, GdO₂, Lu₂O₃ and additional rare earth oxides.

In one aspect the disclosure is directed to a method of making yttrium oxide contain nano-particles, the method comprising preparing a solution Y(NO₃)₃.6H₂O placing the solution in a vessel rotatable table; preparing a solution of ammonia carbonate solution containing ammonia sulfate and 0.2-1.0 wt. % of a water soluble polyethylene glycol as a dispersant; placing the vessel containing the Y(NO₃)₃ solution in a 60-80° C. water bath and titrating the Y(NO₃)₃ solution with the ammonium carbonate solution at the rate of 1-4 ml/min while the vessel containing the Y(NO₃)₃ solution was rotated at a speed in the range of 100-200 rpm to form a uniform precipitation of the yttrium nano-particles; spinning the precipitated yttrium nano-particles with sonication for a time in the range of 2-60 minutes after completion of the titration followed by decantation of the liquid and washing the nano-particles with an alcohol/water solution; collecting and drying the in vacuum at a temperature in the range of 15-30° C. to provide dried yttrium oxide nano-particles; and calcining dried yttrium oxide nano-particles at a temperature in the range of 1050° C. to 1150° C. for a time of at least 2 hours. During the titration of the Y(NO₃)₃ solution the pH of the solution was controlled such that the pH of the precipitated material was in the range of 8.7-9.0. In an embodiment at least one water soluble metal salt is added to the yttrium nitrate solution prior the beginning of the titration for forming a doped yttrium after calcination; the at least one water soluble metal salt being a chloride, nitrate or acetate selected from the group of metal consisting of MgO, CaO, BeO₂, Al₂O3, TiO₂, ZrO₂, SiO₂, HfO₂, YbO₂, GdO₂, Lu₂O₃ and the remaining rare earth metals.

In another aspect the disclosure is directed to a method for forming a yttrium oxide article, the method comprising preparing a solution Y(NO₃)₃.6H₂O placing the solution in a vessel rotatable table; preparing a solution of ammonia carbonate solution containing ammonia sulfate and 0.2-1.0 wt. % of a water soluble polyethylene glycol as a dispersant; placing the vessel containing the Y(NO₃)₃ solution in a 60-80° C. water bath and titrating the Y(NO₃)₃ solution with the ammonium carbonate solution at the rate of 1-4 ml/min while the vessel containing the Y(NO₃)₃ solution was rotated at a speed in the range of 100-200 rpm to form a uniform precipitation of the yttrium nano-particles; spinning the precipitated yttrium nano-particles with sonication for a time in the range of 2-60 minutes after completion of the titration followed by decantation of the liquid and washing the nano-particles with an alcohol/water solution; collecting and drying the in vacuum at a temperature in the range of 15-30° C. to provide dried yttrium oxide nano-particles; calcining dried yttrium oxide nano-particles at a temperature in the range of 1050° C. to 1150° C. for a time of at least 2 hours; placing the calcined nano-particles in a hot isostatic pressing apparatus; sintering the calcined yttrium oxide nano-particle at a temperature in the range of 1200-1500° C. for a time in the range of 4-10 hours in a 15-20% V/V O₂/Ar and a pressure of 1 atmosphere; and hot isostatic pressing by increasing the pressure to 200 MPa and holding the pressure for an additional time in the range 1 hour to 5 hours; and cooling to obtain yttrium oxide article. During the titration of the Y(NO₃)₃ solution the pH of the solution was controlled such that the pH of the precipitated material was in the range of 8.5-9.5 and the pH of the solution was controlled such that the pH of the precipitated material was in the range of 8.7-9.0. In an embodiment at least one water soluble metal salt is added to the yttrium nitrate solution prior the beginning of the titration for forming a doped yttrium after calcination; the at least one water soluble metal salt being a chloride, nitrate or acetate selected from the group of metal consisting of MgO, CaO, BeO₂, Al₂O3, TiO₂, ZrO₂, SiO₂, HfO₂, YbO₂, GdO₂, Lu₂O₃ and the remaining rare earth metals; and the yttrium oxide article that is obtained contains at least one selected metal as a metal oxide.

### BRIEF DESCRIPTION OF THE DRAWINGS

FIG. 1A is a photograph of Y₂O₃ nano-powders synthesized in accordance with the present disclosure.

FIG. 1B is a photograph of particles from the powder of FIG. 1A, the size bars indicating particles of size 15 nm and 17 nm.

FIG. 2A is a photograph of pure Y₂O₃ discs made from the nano-powder disclosed herein.

FIG. 2B is a photograph of the discs that have been sintered and are transparent, the transparent discs being placed over letters on a piece of paper to illustrate the transparency.

FIG. 3A is a surface profile graph, generated by a Zygo® interferometer, illustrating that the surface smoothness of sample discs such as those of FIG. 2A is within the 3-5 nm scale.

FIG. 3B is a surface photograph over a 5 nm portion of as-pressed and unpolished pure Y₂O₃ disc such as shown in FIG. 2A.

FIG. 4 is a graph of transmittance versus wavelength illustrating that sample Y₂O₃ discs (numeral 10) made from the Y₂O₃ nano-powder synthesized in accordance with the disclosure of the have a transmittance that is substantially identical to the theoretical transmittance value (numeral 12).

FIG. 5A is an SEM image of the of an as-synthesized nano-composite consisting of 2 mol % Y₂O₃ and 8 mol % ZrO₂ and showing a 50 nm distance range.

FIG. 5B is the EDAX analysis (energy dispersive x-ray analysis) for the nano-composite of FIG. 5A.

FIG. 6 is flow diagram of the method for preparing the nano-powder according to the disclosure.

FIG. 7 is a transmittance vs. wavelength graph over the 200 nm-845 nm range (0.2 nm-8.24 μm for pure as-produced Y₂O₃ discs (numeral 30) and as-produced discs of pure Y₂O₃ doped with 8 mol % ZrO₂ and 1 mol % MgO (numeral 32).

FIGS. 8A 10 μm full width) and 8B (5 nm full width) are SEM photographs showing the microstructural morphology of composites containing Y₂O₃-8 mol %-ZrO₂-1 mol % MgO composite and show that the average grain size is not larger than 2.5 nm

FIG. 9 is a representative EDX (energy dispersive x-ray) analysis of the grains shown in FIGS. 8A and 8B which confirmed that there was no compositional difference between grains. The letters C, O, Mg, Y and Zr are the peals/elements found in the XRD analysis.

FIGS. 10A-10C are representative nano-indentation and scratch test images of the transparent ceramic composites described herein

### DETAILED DESCRIPTION

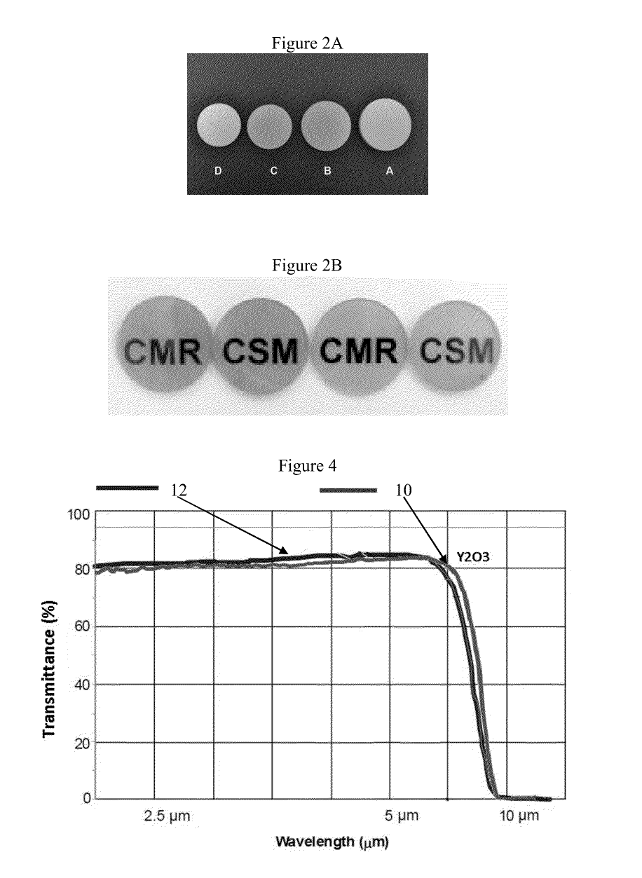

Herein the terms “nano-powder,” “powder,” nano-particles,” and “particles” refer to the as-synthesized nano-material, The term “disc” means nano-powder that that been formed in to selected shaped, such as a disc as illustrated in FIGS. 2A and 2B, and sintered at a sintering temperature for a selected time to form a solid article.

The present disclosure is directed to the synthesis of Y₂O₃ nano-powders, and composites of Y₂O₃/MOₓ (both after sintering), where MOₓ is at least one other metal oxide in which x is in the range of 1-3, using low-cost precursors in a time- and cost-saving way that is also ease to scale up to produce larger amounts of the material. Spinning and ultra-sonication are used to break down the Y₂O₃ soft agglomeration of the Nano powders in a fast and efficient way as compared to either traditional ball-milling, which is time-consuming, or freeze-drying which is expensive to use. The Y₂O₃ nano-powder or Y₂O₃/MOₓ composites, when consolidated as a composite/solid solution systems, including nanocomposites, are designed to and produced to get multiple functional ceramics or materials with improved thermal-mechanical properties compare to the pure Y₂O₃.

In general, the method involves dissolving yttrium nitrate in water in a vessel and titrating the resulting solution with an ammonium carbonate solution containing ammonium sulfate and a water soluble lubricant, for example, commercially available Lutrol E-400 which a polyethylene glycol (BASF) or similar material. The vessel is spun during the titration with control of the pH in the range of 8.3-9.5. In an embodiment the pH is controlled to be in the range of 8.7-9.0. After the titration is completed the precipitated and sonicated for an additional time to homogenize the precipitants. The precipitants are collected on a filter, an vacuum dried. Following the drying the precipitants are calcined.

### EXAMPLES

### 1. Synthesis

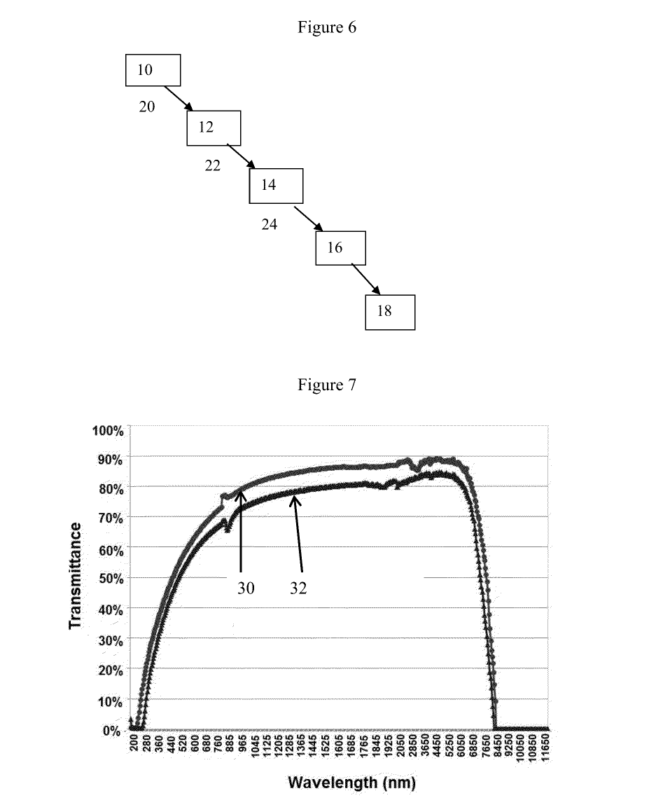

### Illustrated in FIG. 6

(a) Synthesis of Pure Y₂O₃ Nano-Powders

A 0.5M solution Y(NO₃)₃.6H₂O was prepared and place in a vessel. A solution of 2-2.5M ammonia carbonate solution containing 5 Mol % ammonia sulfate and 0.3-0.8 wt. % Lutrol E-400 [a polyethylene glycol, CAS 25322-68-3] as the dispersant. The vessel containing the Y(NO₃)₃ solution was placed in a 70° C. water bath and was titrated with the ammonium carbonate solution at the rate of 2-ml/min ammonia carbonate while the vessel containing the Y(NO₃)₃ solution was spun at a speed in the range of 120-150 rpm to five a uniform precipitation of the yttrium product. During the titration the pH of the solution was controlled such that the pH of the precipitated material was in the range of 8.7-9.0

(b) Synthesis of Y₂O₃-Based Composites/Compounds Y₂O₃/MOₓ (after Sintering)

The amount of the non-yttrium metal is determined beforehand and is added to the yttrium-containing solution. Depending on the amount of non-yttrium material that is used, the final functional material, after sintering and containing yttrium and at least one additional metal, can be a nano-composite or doped ceramic, a solid solution or a compound. The at least one additional metal M can be added to the yttrium containing solution as a nitrate, chloride or other water soluble salt in a selected percentage or Y:M ratio depending on the intended purpose of the final product. The Y/M containing solution is then titrated with an ammonium carbonate solution containing ammonium sulfate and a lubricant as described above and spun at a spinning in the range of 120-150 rpm while maintaining the pH in the range of 8.3-9.5, preferably in the range of 8.7-9.0. The material that can be added into the Y₂O₃ system include MgO, CaO, BaO, BeO₂, Al₂O3, TiO₂, ZrO₂, SiO₂, HfO₂, YbO₂, GdO₂, Lu₂O₃ and additional rare earth oxides. An exemplary Y₂O₃—ZrO₂—MgO composite Y₂O₃ doped with 6-9 mol % ZrO₂ and 0.5-2 mol % MgO. describes herein is a general COMPOSITE system

### 2. Sonication

Once the titration has been completed, the precipitant in the vessel was further spun while sonicating the solution to homogenize the precipitant. This spinning/sonication treatment was done for a time in the range of 5-60 minutes.

### 3. Washing the Precipitate

The fluid in the vessel was decanted and the precipitate was water washed at least once to remove unreacted materials and the lubricant, alcohol washed using a C₁-C₃ alcohol, and was collected on a 0.2 μm-0.4 μm filter paper or equivalent filter, for example a frit filter.

4. The collected precipitate was then vacuum dried at room temperature, approximately 15-30° C., to fully dry and powderize the precipitant.

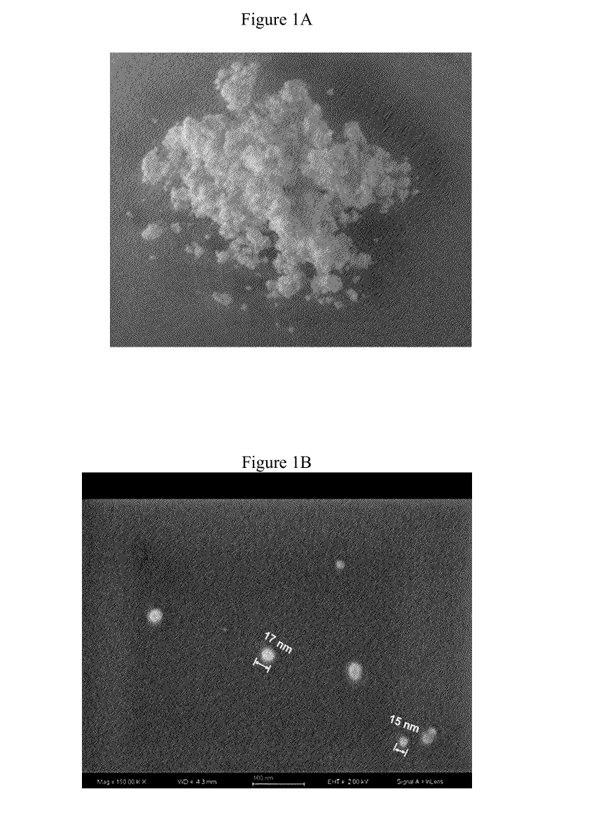

5. After the powder had been dried it was calcined in air at a selected temperature in the range of 1050° C. to 1150° C. for a time of at least 2 hours. In an embodiment the time is at least 4 hours. In a further embodiment the time is at least 6 hours. In an embodiment the calcination temperature 1100° C. and the time was 4 hours. Once the powder was fully dried and calcined it was used to form an article The dried, calcined nano-powder is illustrated in FIGS. 1A and 1B. FIG. 1A illustrates of the dried and calcined nano-powder as a soft agglomeration.

### 6. Compaction and Forming

(a) The calcined powder was suspended in an alcohol solution and ultrasonically treated for a time in the range of 5 minutes to 1 hour to breakdown the soft agglomeration of particles that is illustrated in FIG. 1A. FIG. 1B is a photograph of particles, (he bright spots) from the powder of FIG. 1A after this ultrasonic treatment. In the FIG. 1B photograph the size bars indicate nano-particles, the bright “spots” in the photograph of size 15 nm and 17 nm. In addition, the photograph shows particles as small as approximately 5 nm (the small fuzzy circle to the left of the 17 nm particle).

(b) The dried, ultra-sonicated nano-powder was then pressed into a die at a pressure 1500 psi, followed by cold isostatic pressing of 25-30 kpsi for the final compacting and to form an article that can be further processed.

### 7. Sinter Processing

The sintering conditions may change in accordance with the different chemical components present in the nano-particles and the amount of such components. The sintering can be done as a two-stage process or a one stage process.

(a) Two-Stage Sintering

Two-stage sintering includes:
(1) Sintering in air at a temperature in the range of 1400° C. to 1500° C. for a time in the range of 4 to 10 hours followed by hot isostatic pressing (“HIP”) at a temperature that is 20-50° C. lower than above sintering temperature.
(2) Oxygen annealing to burn out any residual carbon and/or color centers inside the sintered material that are due to the graphite furnace used during HIP treatment.

(b) One-Stage Sintering
One-stage sintering combines the above traditional 2-stage treatments into one-step. The sample is placed directly put into the HIP furnace and is:
(a) Sintered at a temperature in the range of 1400° C.-1500° C. for a time 4 hours to 10 hours using a blended glass consisting of 15-20% O₂—Ar at normal pressure of 1 atmospheric; and
(b) Increasing the pressure during the hot isostatic pressing to 200 MPa and holding the sample at this pressure for an additional time to achieve the best results, such time being in the range of 1 hour to 5 hours.

FIG. 2A illustrates opaque Y₂O₃ green body pellets that were obtained before sintering and FIG. 2B illustrate the transparent pellets that were obtained after sintering. The pellets were placed on a sheet of paper with lettering on it to show the transparency of the sintered pellets.

Some of the major differences between the method describes herein and the art include:

(1) The method disclosed herein does not use any binder or chelating agent s during the synthesis of the pellet.

(2) No sintering aid is added to the during the sintering stage.

(3) An ammonium carbonate solution was used as the precipitating agent instead of the ammonium bicarbonate used in the art. The use of ammonium carbonate results in a better product—fewer color centers, better nano-particle size distribution, fine particle size resulting in a clearer product.

(4) The inclusion of ammonium sulfate in the initial titrating solution and sulfate is included in the initial precipitation product. Sulfur is burned out as a gaseous oxide during the sintering process.

(5) The use of an alcohol washing agent which aids in dehydrating the product and reduces drying time.

(6) Using dispersion in an alcohol solution with sonication to de-agglomerate the soft agglomeration of particles, instead of the traditional ball milling, gives a more uniform nano-particle size distribution.

(7) The use of a 1-state HIP process which results in a time and cost savings over the traditional two-step process.

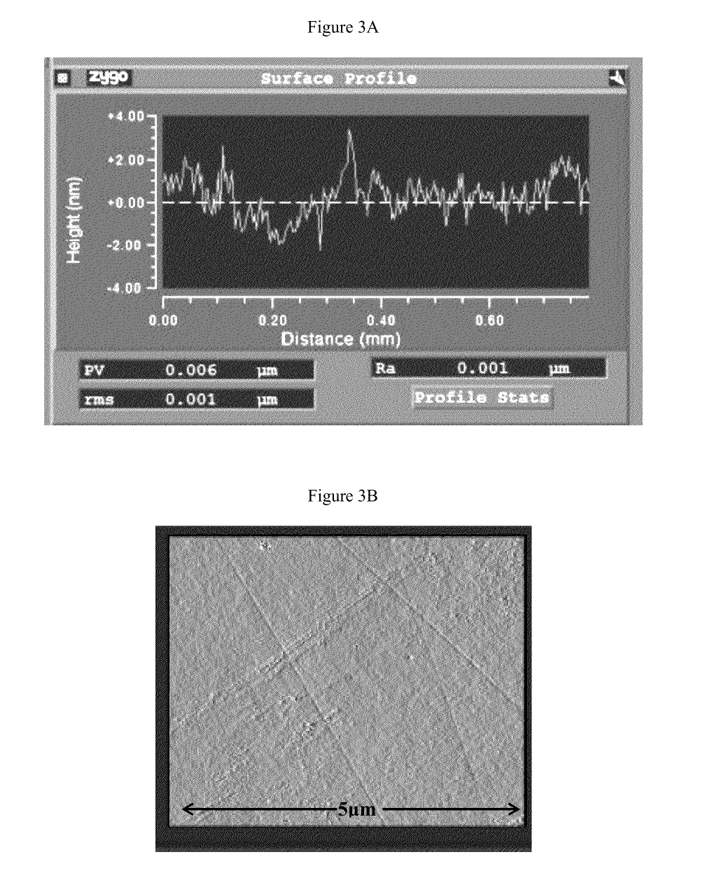

FIG. 3A is a surface profile graph, generated by a Zygo® interferometer, illustrating that the surface smoothness of sample discs such as those of FIG. 2A is within the 3-5 nm scale. The graph indicates that the peak-to-valley (PV) variation is approximately 4 nm and the average PV variation is approximately 0±1.5 nm.

FIG. 3B is a surface photograph over a 5 μm portion of as-pressed and unpolished pure Y₂O₃ disc such as shown in FIG. 2A. The surface indentation are due to the pressing of the material to form the disk and will be substantially removed upon polishing.

FIG. 4 is a graph of transmittance versus wavelength illustrating that sample Y₂O₃ discs (numeral 10) made from the Y₂O₃ nano-powder synthesized in accordance with the disclosure of the have a transmittance that is substantially identical to the theoretical transmittance value (numeral 12).

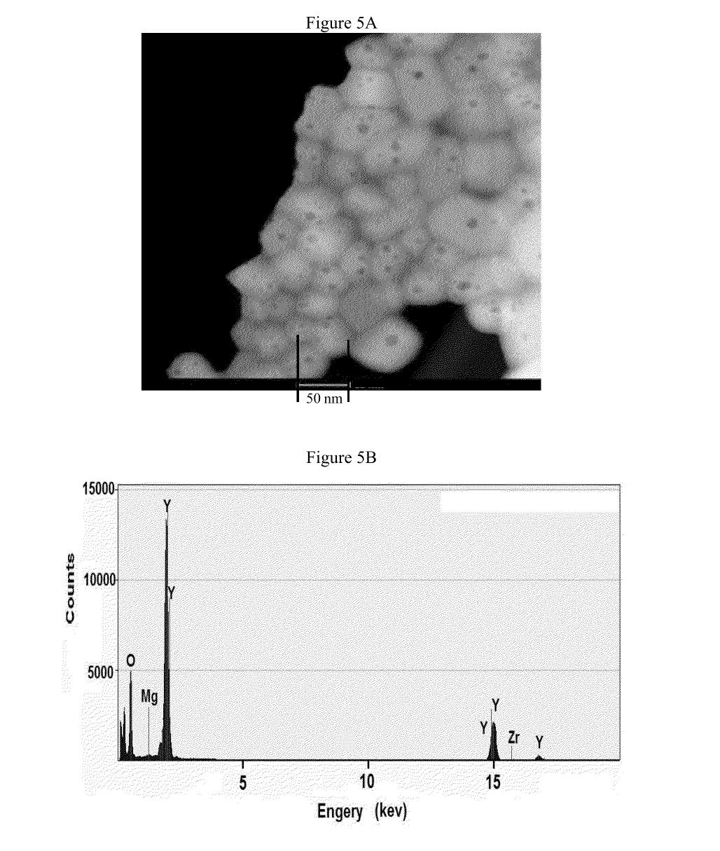

FIG. 5A is an SEM image of the of an as-synthesized nano-composite consisting having the composition of Y₂O₃ doped with 2 mol % MgO and 8 mol % ZrO₂ and showing a 50 nm distance range.

FIG. 5B is the EDAX analysis (energy dispersive x-ray analysis) for the nano-composite of FIG. 5A confirm that the material comprises Y, Mg, Zr and O, with no other materials.

FIG. 6 is flow diagram of the method for preparing the nano-powder according to the disclosure. The numerals 10 to 26 have the meaning shown in Table 1.

TABLE 1

| Numeral | Description |
|---|---|
| 10 | Y₂(NO₃)•6H₂O |
| 12 | Concentration Control |
| 14 | Dispersant |
| 16 | Powderization |
| 18 | Calcination |
| 20 | Different Precipitants |
| 22 | pH Control |
| 24 | Gel Drying |

The collected nano-powder can then be used in forming the batched materials for conversion into the transparent Y₂O₃ based ceramics.

FIG. 7 is a transmittance vs. wavelength graph over the 200 nm-8450 nm range (0.2 μm-8.45 μm) for discs made from pure Y₂O₃ only (numeral 30) discs and discs made from pure Y₂O₃ doped with 8 mol % ZrO₂ and 1 mol % MgO (numeral 32). The graph shown that in the 0.90-7.0 μm the transmission of the Y—Mg—Zr oxide composition is greater than 70% and the transmission is greater than 80% in the 1.6-6.2 μm range. The pure as-produced Y₂O₃ has greater than 70% transmission in the range of 0.7-7.5 μm.

FIGS. 8A (10 μm full width) and 8B (5 μm full width) are SEM photographs showing the microstructural morphology of composites containing the pure Y₂O₃ disclosed herein doped with 8 mol %-ZrO₂-1 mol % MgO, composite and the Figures show that the average grain size is not larger than 2.5 μm

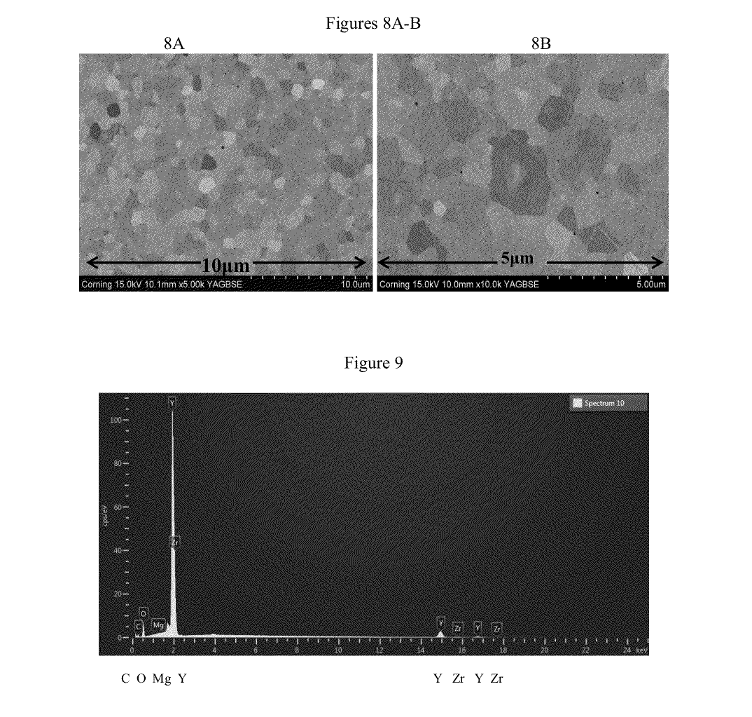

FIG. 9 is a representative EDX (energy dispersive x-ray) analysis of the grains shown in FIGS. 8A and 8B which confirmed that there was no compositional difference between grains.

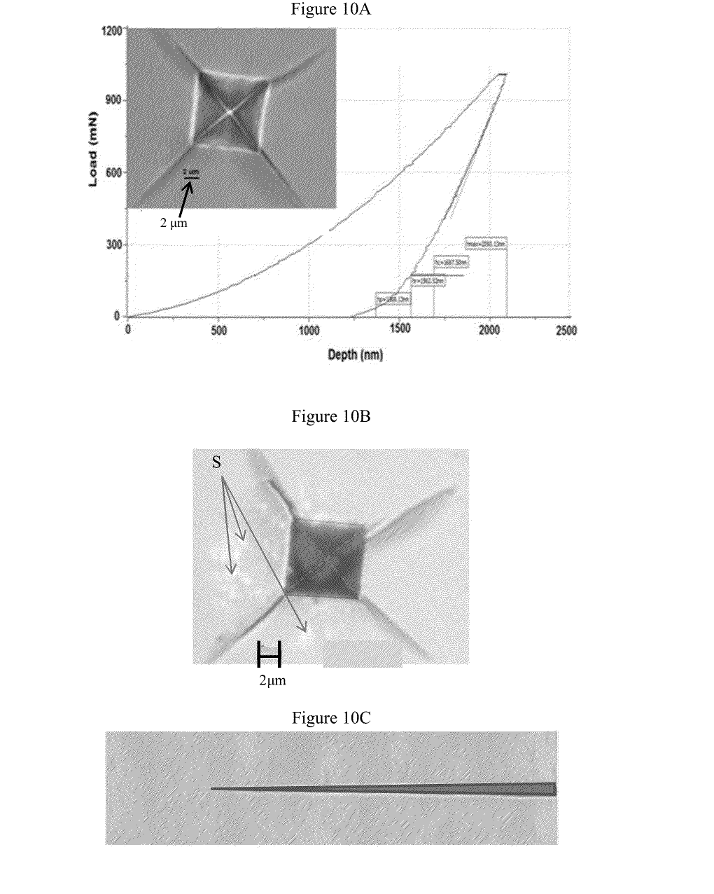

FIGS. 10A-10C are representative nano-indentation and scratch test images of the transparent ceramic composites described herein made from Y₂O₃-8 mol %-ZrO₂-1 mol % MgO (Y—Zr—Mg composite). FIG. 10A shows that the vestige image of the Y—Mg—Zr composite material which has a hardness in the range of 17-18 GPa.

FIG. 10B is a shows the vestige image of a disk make from pure Y₂O₃ only. A comparison of the vestige images of FIGS. 10A and 10B indicate that the 10A image is sharper than that 10B, and that FIG. 10A does not show the spalling and light scattering (arrows S) as is visible in FIG. 10B, The pure Y₂O₃ material in FIG. 10B has a hardness in the range of 9.5-10 GPa.

FIG. 10C is a scratch test of a disc made from the pure Y₂O₃ material of FIG. 10B which shows that the that there is no spalling or micro-crack propagation in the illustrated vestige image. The use of the pure Y₂O₃ material in composites, for example, the composite of FIG. 10A, results in composite ceramics that have good scratch resistance and have a uniform compositional structure. Without being held to any particular theory, uniform compositional structure is believed to play a role in providing good scratch resistance by preventing the formation of softer areas in the final ceramic material.

This disclosure is thus directed to a method of making yttrium oxide nano-particles, yttrium oxide nano-particles containing one or a plurality of selected dopants, and ceramic materials made the nano-particles or doped nano-particles. The method comprises preparing a solution Y(NO₃)₃.6H₂O placing the solution in a vessel rotatable table; preparing a solution of ammonia carbonate solution containing ammonia sulfate and 0.2-1.0 wt. % of a water soluble polyethylene glycol as a dispersant; placing the vessel containing the Y(NO₃)₃ solution in a 60-80° C. water bath and titrating the Y(NO₃)₃ solution with the ammonium carbonate solution at the rate of 1-4 ml/min while the vessel containing the Y(NO₃)₃ solution was rotated at a speed in the range of 100-200 rpm to form a uniform precipitation of the yttrium nano-particles; spinning the precipitated yttrium nano-particles with sonication for a time in the range of 2-60 minutes after completion of the titration followed by decantation of the liquid and washing the nano-particles with an alcohol/water solution; collecting and drying the nano-particles in vacuum at a temperature in the range of 15-30° C. to provide dried yttrium oxide nano-particles; and calcining dried yttrium oxide nano-particles at a temperature in the range of 1050° C. to 1150° C. for a time of at least 2 hours. In one embodiment, during the titration of the Y(NO₃)₃ solution the pH of the solution was controlled such that the pH of the precipitated material was in the range of 8.5-9.5. in another embodiment, during the titration of the Y(NO₃)₃ solution the pH of the solution was controlled such that the pH of the precipitated material was in the range of 8.7-9.0. Making the doped yttrium oxide nanoparticles comprises adding least one water soluble metal salt to the yttrium nitrate solution prior the beginning of the titration for forming a doped yttrium after calcination. The at least one water soluble metal salt is a chloride, nitrate or acetate selected from the group of metal consisting of MgO, CaO, BeO₂, Al₂O3, TiO₂, ZrO₂, SiO₂, HfO₂, YbO₂, GdO₂, Lu₂O₃ and the remaining rare earth metals.

The disclosure is also directed to a method of making yttrium oxide articles, and articles made from a yttrium oxide doped with a selected dopant, the method comprising preparing a solution Y(NO₃)₃.6H₂O placing the solution in a vessel rotatable table; preparing a solution of ammonia carbonate solution containing ammonia sulfate and 0.2-1.0 wt. % of a water soluble polyethylene glycol as a dispersant; placing the vessel containing the Y(NO₃)₃ solution in a 60-80° C. water bath and titrating the Y(NO₃)₃ solution with the ammonium carbonate solution at the rate of 1-4 ml/min while the vessel containing the Y(NO₃)₃ solution was rotated at a speed in the range of 100-200 rpm to form a uniform precipitation of the yttrium nano-particles; spinning the precipitated yttrium nano-particles with sonication for a time in the range of 2-60 minutes after completion of the titration followed by decantation of the liquid and washing the nano-particles with an alcohol/water solution; collecting and drying the in vacuum at a temperature in the range of 15-30° C. to provide dried yttrium oxide nano-particles; calcining dried yttrium oxide nano-particles at a temperature in the range of 1050° C. to 1150° C. for a time of at least 2 hours; placing the calcined nano-particles in a hot isostatic pressing apparatus;

sintering the calcined yttrium oxide nano-particle at a temperature in the range of 1200-1500° C. for a time in the range of 4-10 hours in a 15-20% V/V O₂/Ar and a pressure of 1 atmosphere; and hot isostatic pressing by increasing the pressure to 200 MPa and holding the pressure for an additional time in the range 1 hour to 5 hours; and cooling to obtain yttrium oxide article. In one embodiment, during the titration of the Y(NO₃)₃ solution the pH of the solution was controlled such that the pH of the precipitated material was in the range of 8.5-9.5. In another embodiment, during the titration of the Y(NO₃)₃ solution the pH of the solution was controlled such that the pH of the precipitated material was in the range of 8.7-9.0. In addition, doped yttrium oxide articles can be made from a doped yttrium nano-particle by adding at least one water soluble metal salt to the yttrium nitrate solution prior the beginning of the titration for forming a doped yttrium after calcination. The at least one water soluble metal salt is a chloride, nitrate or acetate selected from the group of metal consisting of MgO, CaO, BeO₂, Al₂O3, TiO₂, ZrO₂, SiO₂, HfO₂, YbO₂, GdO₂, Lu₂O₃ and the remaining rare earth metals. The resulting yttrium oxide article thus contains the at least one selected metal as a metal oxide.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method of making yttrium oxide contain nano-particles, the method comprising:
preparing a solution Y(NO₃)₃.6H₂O placing the solution in a vessel rotatable table;
preparing a solution of ammonia carbonate solution containing ammonia sulfate and 0.2-1.0 wt. % of a water soluble polyethylene glycol as a dispersant;
placing the vessel containing the Y(NO₃)₃ solution in a 60-80° C. water bath and titrating the Y(NO₃)₃ solution with the ammonium carbonate solution at the rate of 1-4 ml/min while the vessel containing the Y(NO₃)₃ solution was rotated at a speed in the range of 100-200 rpm to form a uniform precipitation of the yttrium nano-particles;
spinning the precipitated yttrium nano-particles with sonication for a time in the range of 2-60 minutes after completion of the titration followed by decantation of the liquid and washing the nano-particles with an alcohol/water solution;
collecting and drying the nano-particles in vacuum at a temperature in the range of 15-30° C. to provide dried yttrium oxide nano-particles; and
calcining dried yttrium oxide nano-particles at a temperature in the range of 1050° C. to 1150° C. for a time of at least 2 hours.

2. The method according to claim 1, wherein during the titration of the Y(NO₃)₃ solution the pH of the solution was controlled such that the pH of the precipitated material was in the range of 8.5-9.5.

3. The method according to claim 1, wherein during the titration of the Y(NO₃)₃ solution the pH of the solution was controlled such that the pH of the precipitated material was in the range of 8.7-9.0.

4. The method according to claim 1, wherein at least one water soluble metal salt is added to the yttrium nitrate solution prior the beginning of the titration for forming a doped yttrium after calcination.

5. The method according to claim 4, wherein the at least one water soluble metal salt is a chloride, nitrate or acetate selected from the group of metal consisting of MgO, CaO, BeO₂, Al₂O3, TiO₂, ZrO₂, SiO₂, HfO₂, YbO₂, GdO₂, Lu₂O₃ and the remaining rare earth metals.

6. A method for forming a yttrium oxide article from yttrium oxide nano-particles, the method comprising:
preparing a solution Y(NO₃)₃.6H₂O placing the solution in a vessel rotatable table;
preparing a solution of ammonia carbonate solution containing ammonia sulfate and 0.2-1.0 wt. % of a water soluble polyethylene glycol as a dispersant;
placing the vessel containing the Y(NO₃)₃ solution in a 60-80° C. water bath and titrating the Y(NO₃)₃ solution with the ammonium carbonate solution at the rate of 1-4 ml/min while the vessel containing the Y(NO₃)₃ solution was rotated at a speed in the range of 100-200 rpm to form a uniform precipitation of the yttrium nano-particles;
spinning the precipitated yttrium nano-particles with sonication for a time in the range of 2-60 minutes after completion of the titration followed by decantation of the liquid and washing the nano-particles with an alcohol/water solution;
collecting and drying the in vacuum at a temperature in the range of 15-30° C. to provide dried yttrium oxide nano-particles;
calcining dried yttrium oxide nano-particles at a temperature in the range of 1050° C. to 1150° C. for a time of at least 2 hours;
placing the calcined nano-particles in a hot isostatic pressing apparatus;
sintering the calcined yttrium oxide nano-particle at a temperature in the range of 1200-1500° C. for a time in the range of 4-10 hours in a 15-20% V/V O₂/Ar and a pressure of 1 atmosphere;
and hot isostatic pressing by increasing the pressure to 200 MPa and holding the pressure for an additional time in the range 1 hour to 5 hours; and
cooling to obtain yttrium oxide article.

7. The method according to claim 6, wherein during the titration of the Y(NO₃)₃ solution the pH of the solution was controlled such that the pH of the precipitated material was in the range of 8.5-9.5.

8. The method according to claim 6, wherein during the titration of the Y(NO₃)₃ solution the pH of the solution was controlled such that the pH of the precipitated material was in the range of 8.7-9.0.

9. The method according to claim 6, wherein at least one water soluble metal salt is added to the yttrium nitrate solution prior the beginning of the titration for forming a doped yttrium after calcination.

10. The method according to claim 4, wherein the at least one water soluble metal salt is a chloride, nitrate or acetate selected from the group of metal consisting of MgO, CaO, BeO₂, Al₂O3, TiO₂, ZrO₂, SiO₂, HfO₂, YbO₂, GdO₂, Lu₂O₃ and the remaining rare earth metals.

11. The method according to claim 10, wherein the yttrium oxide article contain the at least one selected metal as a metal oxide.
